(19) United States
(12) Patent Application Publication
(10) Pub. No.: US 2024/0196032 A1
(43) Pub. Date: Jun. 13, 2024

(54) SYSTEM, METHOD AND COMPUTER-READABLE MEDIUM FOR DISTRIBUTION TIME SUGGESTION

(71) Applicant: 17LIVE Japan Inc., Tokyo (JP)

(72) Inventors: Chi-Wei LIN, Taipei City (TW); Yung-Chi HSU, Taipei City (TW); Shao-Tang CHIEN, Taipei City (TW)

(21) Appl. No.: 18/364,344

(22) Filed: Aug. 2, 2023

(30) Foreign Application Priority Data
Dec. 12, 2022 (JP) 2022-197705
Jan. 19, 2023 (JP) 2023-006756

(51) Int. Cl. H04N 21/262; H04N 21/24; H04N 21/25

(52) U.S. Cl. CPC H04N 21/26241; H04N 21/2407; H04N 21/252

(57) ABSTRACT

The present disclosure relates to a system, a method and a computer-readable medium for distribution time suggestion. The method includes obtaining a first list of viewers in association with a first distributor; obtaining data of the viewers in the first list; obtaining a second list of distributors in association with the viewers in the first list; obtaining data of the distributors in the second list; and determining a distribution time for the first distributor according to the data of the viewers in the first list and the data of the distributors in the second list.

### CROSS-REFERENCE TO RELATED APPLICATIONS

This application is based on and claims the benefit of priority from Japanese Patent Application Serial No. 2022-197705 (filed on Dec. 12, 2022) and Japanese Patent Application Serial No. 2023-006756 (filed on Jan. 19, 2023), the contents of which are hereby incorporated by reference in their entirety.

### TECHNICAL FIELD

The present disclosure relates to streaming time suggestions in the live streaming field.

The present disclosure also relates to viewer contribution prediction in the live streaming field.

### BACKGROUND

Real time interaction on the Internet, such as live streaming service, has become popular in our daily life. There are various platforms or providers providing the service of live streaming, and the competition is fierce. It is important for a platform to help its content providers (or content distributors) to generate rewards or revenue in an efficient manner, for example, by identifying users with higher potential of achieving higher contribution for the content providers.

US patent application publication US20220383234A1 discloses a method for scheduling live events for one or more performers in a plurality of geographic locations. Chinese patent application publication CN114268841A discloses a method for selecting users for live interaction.

### SUMMARY

A method according to one embodiment of the present disclosure is a method for distribution time suggestion being executed by one or a plurality of computers, and includes: obtaining a first list of viewers in association with a first distributor; obtaining data of the viewers in the first list; obtaining a second list of distributors in association with the viewers in the first list; obtaining data of the distributors in the second list; and determining a distribution time for the first distributor according to the data of the viewers in the first list and the data of the distributors in the second list.

A system according to one embodiment of the present disclosure is a system for distribution time suggestion that includes one or a plurality of processors, and the one or plurality of computer processors execute a machine-readable instruction to perform: obtaining a first list of viewers in association with a first distributor; obtaining data of the viewers in the first list; obtaining a second list of distributors in association with the viewers in the first list; obtaining data of the distributors in the second list; and determining a distribution time for the first distributor according to the data of the viewers in the first list and the data of the distributors in the second list.

A computer-readable medium according to one embodiment of the present disclosure is a non-transitory computer-readable medium including a program for distribution time suggestion, and the program causes one or a plurality of computers to execute: obtaining a first list of viewers in association with a first distributor; obtaining data of the viewers in the first list; obtaining a second list of distributors in association with the viewers in the first list; obtaining data of the distributors in the second list; and determining a distribution time for the first distributor according to the data of the viewers in the first list and the data of the distributors in the second list.

A method according to another embodiment of the present disclosure is a method for viewer contribution prediction being executed by one or a plurality of computers, and includes: determining a contribution amount of a viewer with respect to a first distributor to be less than a contribution threshold of the first distributor; obtaining a value of an interaction parameter of the viewer with respect to the first distributor; and determining a contribution prediction of the viewer with respect to the first distributor according to the value of the interaction parameter of the viewer with respect to the first distributor by a machine learning model.

A system according to another embodiment of the present disclosure is a system for viewer contribution prediction that includes one or a plurality of processors, and the one or plurality of computer processors execute a machine-readable instruction to perform: determining a contribution amount of a viewer with respect to a first distributor to be less than a contribution threshold of the first distributor; obtaining a value of an interaction parameter of the viewer with respect to the first distributor; and determining a contribution prediction of the viewer with respect to the first distributor according to the value of the interaction parameter of the viewer with respect to the first distributor by a machine learning model.

A computer-readable medium according to another embodiment of the present disclosure is a non-transitory computer-readable medium including a program for viewer contribution prediction, and the program causes one or a plurality of computers to execute: determining a contribution amount of a viewer with respect to a first distributor to be less than a contribution threshold of the first distributor; obtaining a value of an interaction parameter of the viewer with respect to the first distributor; and determining a contribution prediction of the viewer with respect to the first distributor according to the value of the interaction parameter of the viewer with respect to the first distributor by a machine learning model.

### BRIEF DESCRIPTION OF THE DRAWINGS

FIG. 1 shows a schematic configuration of a live streaming system 1 according to some embodiments of the present disclosure.

FIG. 2 is a block diagram showing functions and configuration of the user terminal 30 of FIG. 1 according to some embodiments of the present disclosure.

FIG. 3 shows a block diagram illustrating functions and configuration of the server 10 of FIG. 1 according to some embodiments of the present disclosure.

FIG. 4 is a data structure diagram of an example of the stream DB 310 of FIG. 3.

FIG. 5 is a data structure diagram showing an example of the user DB 312 of FIG. 3.

FIG. 6 is a data structure diagram showing an example of the gift DB 314 of FIG. 3.

FIG. 7 is a data structure diagram showing an example of the contribution DB 350 of FIG. 3.

FIG. 8 shows exemplary daily contribution data between a viewer and a distributor.

FIG. 9 is a data structure diagram showing an example of the schedule DB 352 of FIG. 3.

FIG. 10 shows an exemplary flow chart illustrating a method according to some embodiments of the present disclosure.

FIG. 11 shows an example of distribution time suggestion according to some embodiments of the present disclosure.

FIG. 12 is a data structure diagram showing an example of the interaction parameter DB 354 of FIG. 3.

FIG. 13 shows another exemplary flow chart illustrating a method according to some embodiments of the present disclosure.

FIG. 14 shows an example of how the ML model 370 determines or calculates the contribution prediction according to some embodiments of the present disclosure.

FIG. 15 shows exemplary training and inference phases of the ML model 370 according to some embodiments of the present disclosure.

FIG. 16 shows an example of a live streaming screen on the user terminal of a distributor according to some embodiments of the present disclosure.

FIG. 17 shows an example of a live streaming screen on the user terminal of a distributor according to some embodiments of the present disclosure.

FIGS. 18(a), 18(b) and 18(c) show examples of contribution prediction according to some embodiments of the present disclosure.

FIG. 19 is a block diagram showing an example of a hardware configuration of the information processing device according to some embodiments of the present disclosure.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

Conventionally, content providers (such as distributors, broadcasters, streamers, livers or anchors) on the internet (such as streaming platforms or live streaming platforms) do not have good tools for identifying the time (e.g., timing or time span) to perform the content distribution. The distributors cannot know when to perform the distribution to achieve higher rewards (such as revenue) in an efficient manner. The content providers also do not have good tools of identifying viewers who are more likely to have higher contribution (such as revenue contribution) on the platform (or to the content provider). The distributors cannot know who are the potential contributors, and therefore cannot act accordingly.

The present disclosure provides systems or methods to analyze the viewers and to identify potential contributors for the distributors. Therefore, the distributors can direct more of their limited resources (such as time, attention or event) to the higher-potential viewers, which can increase the reward for the distributors in a more precise and more efficient way.

The present disclosure provides systems or methods to analyze the viewers and the distributors, to identify the best or the most profitable time for a distributor to distribute contents. The present disclosure also provides systems or methods to analyze the viewers and to identify potential contributors for the distributors. Therefore, the distributors can direct more of their limited resources (such as time, attention or event) to the higher-potential viewers, which can increase the reward for the distributors in a more precise and more efficient way.

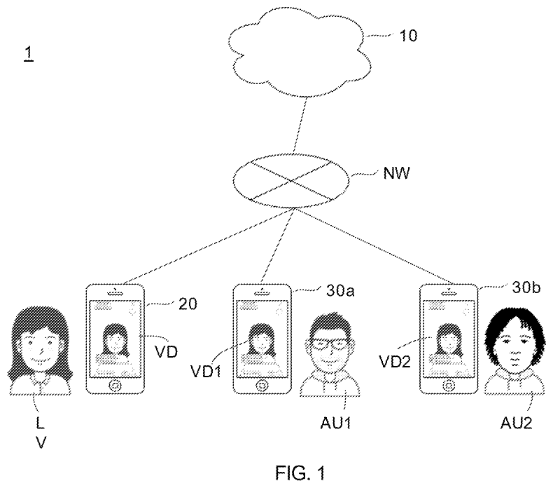

FIG. 1 shows a schematic configuration of a live streaming system 1 according to some embodiments of the present disclosure. The live streaming system 1 provides a live streaming service for the streaming streamer (could be referred to as liver, anchor, or distributor) LV and viewer (could be referred to as audience) AU (AU1, AU2 . . . ) to interact or communicate in real time. As shown in FIG. 1, the live streaming system 1 includes a server 10, a user terminal 20 and user terminals 30 (30a, 30b . . . ). In some embodiments, the streamers and viewers may be collectively referred to as users. The server 10 may include one or a plurality of information processing devices connected to a network NW. The user terminal 20 and 30 may be, for example, mobile terminal devices such as smartphones, tablets, laptop PCs, recorders, portable gaming devices, and wearable devices, or may be stationary devices such as desktop PCs. The server 10, the user terminal 20 and the user terminal 30 are interconnected so as to be able to communicate with each other over the various wired or wireless networks NW.

The live streaming system 1 involves the distributor LV, the viewers AU, and an administrator (or an APP provider, not shown) who manages the server 10. The distributor LV is a person who broadcasts contents in real time by recording the contents with his/her user terminal 20 and uploading them directly or indirectly to the server 10. Examples of the contents may include the distributor's own songs, talks, performances, gameplays, and any other contents. The administrator provides a platform for live-streaming contents on the server 10, and also mediates or manages real-time interactions between the distributor LV and the viewers AU. The viewer AU accesses the platform at his/her user terminal 30 to select and view a desired content. During live-streaming of the selected content, the viewer AU performs operations to comment, cheer, or send gifts via the user terminal 30. The distributor LV who is delivering the content may respond to such comments, cheers, or gifts. The response is transmitted to the viewer AU via video and/or audio, thereby establishing an interactive communication.

The term “live-streaming” may mean a mode of data transmission that allows a content recorded at the user terminal 20 of the distributor LV to be played or viewed at the user terminals 30 of the viewers AU substantially in real time, or it may mean a live broadcast realized by such a mode of transmission. The live-streaming may be achieved using existing live delivery technologies such as HTTP Live Streaming Common Media Application Format, Web Real-Time Communications, Real-Time Messaging Protocol and MPEG DASH. Live-streaming includes a transmission mode in which the viewers AU can view a content with a specified delay simultaneously with the recording of the content by the distributor LV. As for the length of the delay, it may be acceptable for a delay with which interaction between the distributor LV and the viewers AU can be established. Note that the live-streaming is distinguished from so-called on-demand type transmission, in which the entire recorded data of the content is once stored on the server, and the server provides the data to a user at any subsequent time upon request from the user.

The term “video data” herein refers to data that includes image data (also referred to as moving image data) generated using an image capturing function of the user terminals 20 or 30, and audio data generated using an audio input function of the user terminals 20 or 30. Video data is reproduced in the user terminals 20 and 30, so that the users can view contents. In some embodiments, it is assumed that between video data generation at the distributor's user terminal and video data reproduction at the viewer's user terminal, processing is performed onto the video data to change its format, size, or specifications of the data, such as compression, decompression, encoding, decoding, or transcoding. However, the content (e.g., video images and audios) represented by the video data before and after such processing does not substantially change, so that the video data after such processing is herein described as the same as the video data before such processing. In other words, when video data is generated at the distributor's user terminal and then played back at the viewer's user terminal via the server 10, the video data generated at the distributor's user terminal, the video data that passes through the server 10, and the video data received and reproduced at the viewer's user terminal are all the same video data.

In the example in FIG. 1, the distributor LV provides the live streaming data. The user terminal 20 of the distributor LV generates the streaming data by recording images and sounds of the distributor LV, and the generated data is transmitted to the server 10 over the network NW. At the same time, the user terminal 20 displays a recorded video image VD of the distributor LV on the display of the user terminal 20 to allow the distributor LV to check the live streaming contents currently performed.

The user terminals 30a and 30b of the viewers AU1 and AU2 respectively, who have requested the platform to view the live streaming of the distributor LV, receive video data related to the live streaming (may also be herein referred to as “live-streaming video data”) over the network NW and reproduce the received video data to display video images VD1 and VD2 on the displays and output audio through the speakers. The video images VD1 and VD2 displayed at the user terminals 30a and 30b, respectively, are substantially the same as the video image VD captured by the user terminal 20 of the distributor LV, and the audio outputted at the user terminals 30a and 30b is substantially the same as the audio recorded by the user terminal 20 of the distributor LV.

Recording of the images and sounds at the user terminal 20 of the distributor LV and reproduction of the video data at the user terminals 30a and 30b of the viewers AU1 and AU2 are performed substantially simultaneously. Once the viewer AU1 types a comment about the contents provided by the distributor LV on the user terminal 30a, the server 10 displays the comment on the user terminal 20 of the distributor LV in real time and also displays the comment on the user terminals 30a and 30b of the viewers AU1 and AU2, respectively. When the distributor LV reads the comment and develops his/her talk to cover and respond to the comment, the video and sound of the talk are displayed on the user terminals 30a and 30b of the viewers AU1 and AU2, respectively. This interactive action is recognized as the establishment of a conversation between the distributor LV and the viewer AU1. In this way, the live streaming system 1 realizes the live streaming that enables interactive communication, not one-way communication.

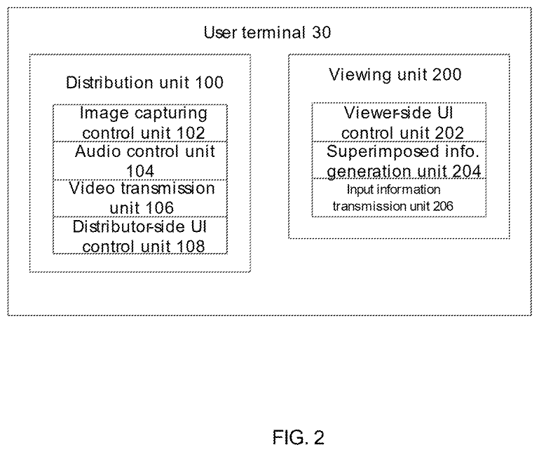

FIG. 2 is a block diagram showing functions and configuration of the user terminal 30 of FIG. 1 according to some embodiments of the present disclosure. The user terminal 20 has the same or similar functions and configuration as the user terminal 30. Each block in FIG. 2 and the subsequent block diagrams may be realized by elements such as a computer CPU or a mechanical device in terms of hardware, and can be realized by a computer program or the like in terms of software. Functional blocks could be realized by cooperative operation between these elements. Therefore, it is understood by those skilled in the art that these functional blocks can be realized in various forms by combining hardware and software.

The distributor LV and the viewers AU may download and install a live streaming application program (hereinafter referred to as a live streaming application) to the user terminals 20 and 30 from a download site over the network NW. Alternatively, the live streaming application may be pre-installed on the user terminals 20 and 30. When the live streaming application is executed on the user terminals 20 and 30, the user terminals 20 and 30 communicate with the server 10 over the network NW to implement or execute various functions. Hereinafter, the functions implemented by the user terminals 20 and 30 (processors such as CPUs) in which the live streaming application is run will be described as functions of the user terminals 20 and 30. These functions are realized in practice by the live streaming application on the user terminals 20 and 30. In some embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 30 includes a distribution unit 100 and a viewing unit 200. The distribution unit 100 generates video data in which the user's (or the user side's) image and sound are recorded, and provides the video data to the server 10. The viewing unit 200 receives video data from the server 10 to reproduce the video data. The user activates the distribution unit 100 when the user performs live streaming, and activates the viewing unit 200 when the user views a video. The user terminal in which the distribution unit 100 is activated is the distributor's terminal, i.e., the user terminal that generates the video data. The user terminal in which the viewing unit 200 is activated is the viewer's terminal, i.e., the user terminal in which the video data is reproduced and played.

The distribution unit 100 includes an image capturing control unit 102, an audio control unit 104, a video transmission unit 106, and a distribution-side UI control unit 108. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time. The distribution-side UI control unit 108 controls an UI (user interface) for the distributor. The distribution-side UI control unit 108 may be connected to a display (not shown in FIG. 2), and displays a video on the display by reproducing the video data that is to be transmitted by the video transmission unit 106. The distribution-side UI control unit 108 may display an operation object or an instruction-accepting object on the display, and accepts inputs from the distributor who taps on the object.

The viewing unit 200 includes a viewer-side UI control unit 202, a superimposed information generation unit 204, and an input information transmission unit 206. The viewing unit 200 receives, from the server 10 over the network NW, video data related to the live streaming in which the distributor, the viewer who is the user of the user terminal 30, and other viewers participate. The viewer-side UI control unit 202 controls the UI for the viewers. The viewer-side UI control unit 202 is connected to a display and a speaker (not shown in FIG. 2), and reproduces the received video data to display video images on the display and output audio through the speaker. The state where the image is outputted to the display and the audio is outputted from the speaker can be referred to as “the video data is played”. The viewer-side UI control unit 202 is also connected to input means (not shown in FIG. 2) such as touch panels, keyboards, and displays, and obtains user input via these input means. The superimposed information generation unit 204 superimposes a predetermined frame image on an image generated from the video data from the server 10. The frame image includes various user interface objects (hereinafter simply referred to as “objects”) for accepting inputs from the user, comments entered by the viewers, and/or information obtained from the server 10. The input information transmission unit 206 transmits the user input obtained by the viewer-side UI control unit 202 to the server 10 over the network NW.

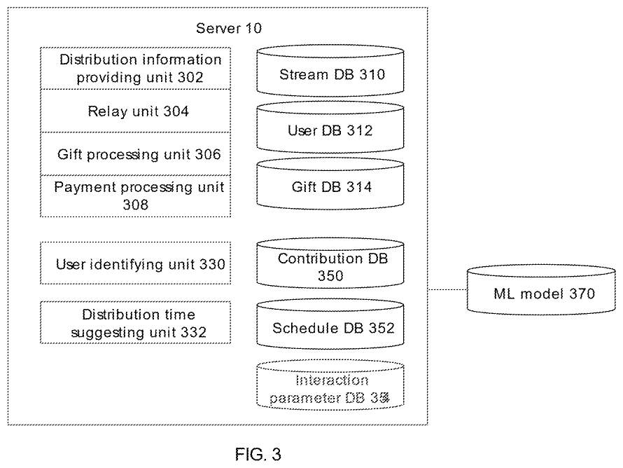

FIG. 3 shows a block diagram illustrating functions and configuration of the server 10 of FIG. 1 according to some embodiments of the present disclosure. The server 10 includes a distribution information providing unit 302, a relay unit 304, a gift processing unit 306, a payment processing unit 308, a stream DB 310, a user DB 312, a gift DB 314, a user identifying unit 330, a distribution time suggesting unit 332, a contribution DB 350, a schedule DB 352, and an interaction parameter DB 354. The server 10 communicates with a machine learning (ML) model 370.

Upon reception of a notification or a request from the user terminal 20 on the distributor side to start a live streaming over the network NW, the distribution information providing unit 302 registers a stream ID for identifying this live streaming and the distributor ID of the distributor who performs the live streaming in the stream DB 310.

When the distribution information providing unit 302 receives a request to provide information about live streams from the viewing unit 200 of the user terminal 30 on the viewer side over the network NW, the distribution information providing unit 302 retrieves or checks currently available live streams from the stream DB 310 and makes a list of the available live streams. The distribution information providing unit 302 transmits the generated list to the requesting user terminal 30 over the network NW. The viewer-side UI control unit 202 of the requesting user terminal 30 generates a live stream selection screen based on the received list and displays it on the display of the user terminal 30.

Once the input information transmission unit 206 of the user terminal 30 receives the viewer's selection result on the live stream selection screen, the input information transmission unit 206 generates a distribution request including the stream ID of the selected live stream, and transmits the request to the server 10 over the network NW. The distribution information providing unit 302 starts providing, to the requesting user terminal 30, the live stream specified by the stream ID included in the received distribution request. The distribution information providing unit 302 updates the stream DB 310 to include the user ID of the viewer of the requesting user terminal 30 into the viewer IDs of (or corresponding to) the stream ID.

The relay unit 304 relays the video data from the distributor-side user terminal 20 to the viewer-side user terminal 30 in the live streaming started by the distribution information providing unit 302. The relay unit 304 receives from the input information transmission unit 206 a signal that represents user input by a viewer during the live streaming or reproduction of the video data. The signal that represents user input may be an object specifying signal for specifying an object displayed on the display of the user terminal 30. The object specifying signal may include the viewer ID of the viewer, the distributor ID of the distributor of the live stream that the viewer watches, and an object ID that identifies the object. When the object is a gift, the object ID is the gift ID. Similarly, the relay unit 304 receives, from the distribution unit 100 of the user terminal 20, a signal that represents user input performed by the distributor during reproduction of the video data (or during the live streaming). The signal could be an object specifying signal.

Alternatively, the signal that represents user input may be a comment input signal including a comment entered by a viewer into the user terminal 30 and the viewer ID of the viewer. Upon reception of the comment input signal, the relay unit 304 transmits the comment and the viewer ID included in the signal to the user terminal 20 of the distributor and the user terminals 30 of other viewers. In these user terminals 20 and 30, the viewer-side UI control unit 202 and the superimposed information generation unit 204 display the received comment on the display in association with the viewer ID also received.

The gift processing unit 306 updates the user DB 312 so as to increase the points of the distributor depending on the points of the gift identified by the gift ID included in the object specifying signal. Specifically, the gift processing unit 306 refers to the gift DB 314 to specify the points to be granted for the gift ID included in the received object specifying signal. The gift processing unit 306 then updates the user DB 312 to add the determined points to the points of (or corresponding to) the distributor ID included in the object specifying signal.

The payment processing unit 308 processes payment of a price of a gift from a viewer in response to reception of the object specifying signal. Specifically, the payment processing unit 308 refers to the gift DB 314 to specify the price points of the gift identified by the gift ID included in the object specifying signal. The payment processing unit 308 then updates the user DB 312 to subtract the specified price points from the points of the viewer identified by the viewer ID included in the object specifying signal.

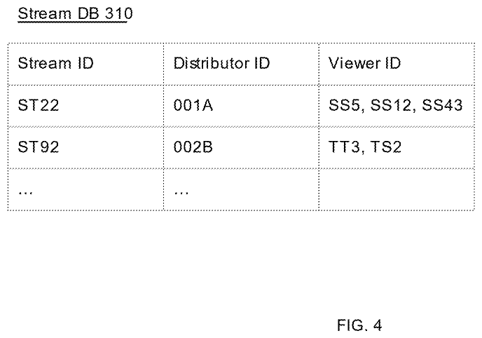

FIG. 4 is a data structure diagram of an example of the stream DB 310 of FIG. 3. The stream DB 310 holds information regarding a live stream currently taking place. The stream DB 310 stores the stream ID, the distributor ID and the viewer ID, in association with each other. The stream ID is for identifying a live stream on a live streaming platform provided by the live streaming system 1. The distributor ID is a user ID for identifying the distributor who provides the live stream. The viewer ID is a user ID for identifying a viewer of the live stream. In the live streaming platform provided by the live streaming system 1 of some embodiments, when a user starts a live stream, the user becomes a distributor, and when the same user views a live stream broadcast by another user, the user also becomes a viewer. Therefore, the distinction between a distributor and a viewer is not fixed, and a user ID registered as a distributor ID at one time may be registered as a viewer ID at another time.

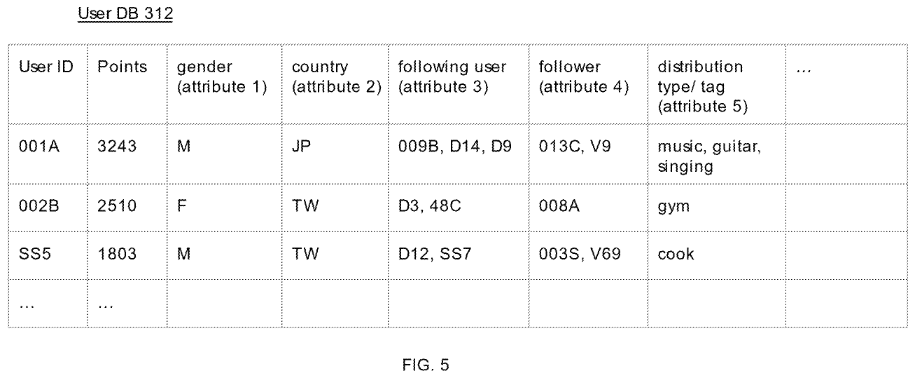

FIG. 5 is a data structure diagram showing an example of the user DB 312 of FIG. 3. The user DB 312 holds information regarding users. The user DB 312 stores the user ID, the point, and one or more attributes (attribute 1, 2, . . . ), in association with each other. The user ID identifies a user. The point corresponds to the points the corresponding user holds. The point is the electronic value circulated within the live streaming platform. In some embodiments, when a distributor receives a gift from a viewer during a live stream, the distributor's points increase by the value corresponding to the gift. The points are used, for example, to determine the amount of reward (such as money) the distributor receives from the administrator of the live streaming platform. In some embodiments, when the distributor receives a gift from a viewer, the distributor may be given the amount of money corresponding to the gift instead of the points.

Examples of the attributes may include: gender, country, following user, follower, distribution type (or distribution tag), deposit amount and/or viewer level. The following user means the distributors the corresponding user follows. The follower means the viewers following the corresponding user. The deposit amount is the amount of money the corresponding user deposits in the platform. The viewer level may increase along with the deposit amount of the corresponding user. Some attributes, such as gender, may be input from the user when registering at the platform. Some attributes, such as country, may be detected by a detecting unit (not shown in FIG. 3) within the server 10 or outside the server 10. The examples of the attributes may include the number of distributors the corresponding user follows and/or the number of viewers following the corresponding user.

The distribution type or distribution tag indicates the type(s) of the distribution content of the corresponding user. The tags may be determined by the ML model 370 (or a ML algorithm within the ML model 370). The tag determination may include image identification process, sound identification process, video identification process or motion identification process. In some embodiments, if the number of similar distribution tags (or same distribution tags) shared by two distributors reach a threshold value, the two distributors may be referred to as similar distributors.

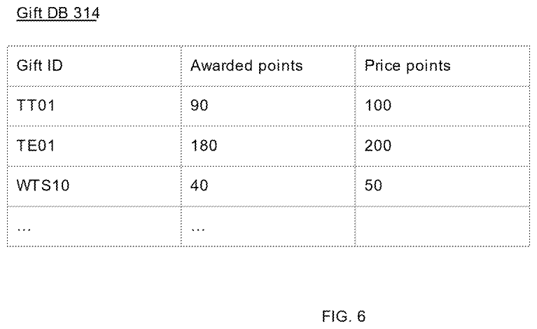

FIG. 6 is a data structure diagram showing an example of the gift DB 314 of FIG. 3. The gift DB 314 holds information regarding gifts available for the viewers in the live streaming. A gift is electronic data. A gift may be purchased with the points or money, or can be given for free. A gift may be given by a viewer to a distributor. Giving a gift to a distributor is also referred to as using, sending, or throwing the gift. Some gifts may be purchased and used at the same time, and some gifts may be purchased and then used at any time later by the purchaser viewer. When a viewer gives a gift to a distributor, the distributor is awarded the amount of points corresponding to the gift. When a gift is used, the use may trigger an effect associated with the gift. For example, an effect (such as visual or sound effect) corresponding to the gift will appear on the live streaming screen.

The gift DB 314 stores the gift ID, the awarded points, and the price points, in association with each other. The gift ID is for identifying a gift. The awarded points are the amount of points awarded to a distributor when the gift is given to the distributor. The price points are the amount of points to be paid for use (or purchase) of the gift. A viewer is able to give a desired gift to a distributor by paying the price points of the desired gift when the viewer is viewing the live stream. The payment of the price points may be made by an appropriate electronic payment means. For example, the payment may be made by the viewer paying the price points to the administrator. Alternatively, bank transfers or credit card payments may be used. The administrator is able to desirably set the relationship between the awarded points and the price points. For example, it may be set as the awarded points=the price points. Alternatively, points obtained by multiplying the awarded points by a predetermined coefficient such as 1.2 may be set as the price points, or points obtained by adding predetermined fee points to the awarded points may be set as the price points.

The user identifying unit 330 is configured to identify (or determine) the users who are related to the determination of a distribution time for a distributor. For example, the user identifying unit 330 may identify the viewers in association with the distributor. For example, the user identifying unit 330 may identify the users eligible to view a live stream of the distributor. The user identifying unit 330 may identify the users eligible to receive a notification about a live stream of the distributor, such as followers of the distributor. The user identifying unit 330 may be configured to determine or predict whether a particular viewer is a potential top contributor (or potential high contributor) to a particular distributor.

The user identifying unit 330 may identify the users who are in association with the followers of the distributor. For example, the user identifying unit 330 may identify the users who are followed by the followers of the distributor, such as other distributors. The user identifying unit 330 may refer to the stream DB 310, the user DB 312, the gift DB 314, the contribution DB 350, the schedule DB 352 and/or the interaction parameter DB 354 for the identification process. The user identifying unit 330 may be configured to utilize the ML model 370 for the determination or prediction. The determination or prediction result may be stored or registered, as the top contributor tag and/or the potential top contributor tag, into the contribution DB 350. The details will be described later.

The distribution time suggesting unit 332 is configured to determine or suggest a distribution time for a distributor. The distribution time may be determined according to the viewers and/or the distributors identified by the user identifying unit 330. For example, the distribution time may be determined according to data of the distributor's followers and/or data of other distributors followed by the distributor's followers. In some embodiments, the distribution time suggesting unit 332 may input the above data into the ML model 370 to deliver the suggested distribution time.

For example, the distribution time suggesting unit 332 may refer to the contribution DB for contribution predictions (such as the information about potential top contributors) of the viewers/followers of the distributor, and suggest the distribution time accordingly. For example, the distribution time suggesting unit 332 may refer to the user DB 312 for attributes of other distributors and the distributor, calculate similarity scores of other distributors with respect to the distributor according to those attributes, and suggest the distribution time accordingly. For example, the distribution time suggesting unit 332 may refer to the schedule DB 352 for distribution schedules of other distributors, and suggest the distribution time accordingly. For example, the distribution time suggesting unit 332 may refer to the schedule DB 352 for viewing schedules (or viewing time) of the viewers/followers of the distributor, and suggest the distribution time accordingly.

In some embodiments, the distribution time (suggested by the distribution time suggesting unit 332 to the distributor) is determined to have the least overlap with distribution time of other distributors having similar attributes with the distributor. The viewers' (or followers') attention can be focused on the distributor's distribution without being distracted by other distributors. In some embodiments, the distribution time is determined to have the most overlap with viewing time of the viewers (or the distributor's followers) whose contribution predictions are greater than a contribution threshold. The distributor's distribution can be shown to more viewers with high contribution potentials. The distributor can improve his or her rewards in an efficient manner.

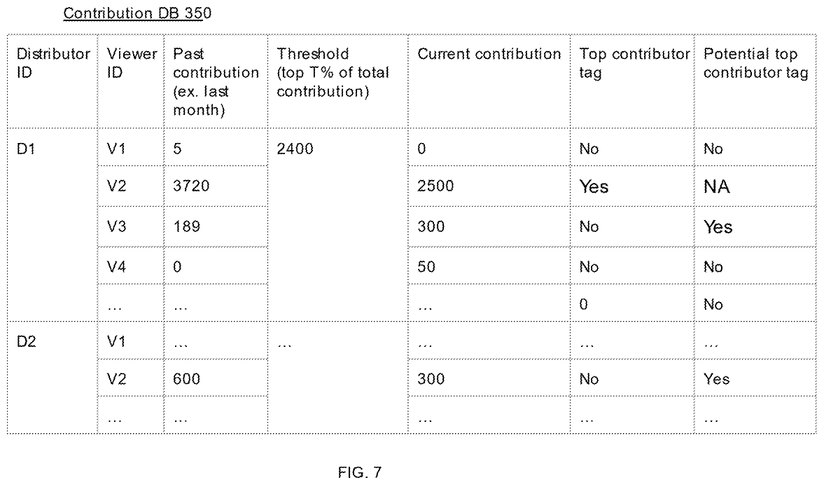

FIG. 7 is a data structure diagram showing an example of the contribution DB 350 of FIG. 3. The contribution DB 350 holds the distributor ID, the viewer ID, the past contribution, the threshold (or contribution threshold), the current contribution, the top contributor tag, and the potential top contributor tag, in association with each other.

The past contribution is the contribution amount given from a viewer to a distributor, in a predetermined time period (for example, in the past one month).

The threshold or contribution threshold is used to determine if a viewer is a top contributor (or high contributor) for a distributor. The threshold is top T % (or first T % quantile) of total contribution from all viewers of a distributor to the distributor. In some embodiments, the threshold could be the first Y quantile of total contribution from all viewers of a distributor to the distributor. Therefore, the threshold could be different for each distributor. The threshold is also renewed every predetermined time period.

The current contribution is updated in a real time manner according to the contribution status from a viewer to a distributor, in the current calculating period.

The top contributor tag indicates if a viewer is already registered as a top contributor (or high contributor, or top spender) for a distributor. Once the current contribution exceeds the contribution threshold, the corresponding viewer would be registered as a top contributor for the corresponding distributor. For example, viewer V2's current contribution [2500 points] already exceeds the threshold [2400 points] for distributor D1, therefore viewer V2 is registered as top contributor for distributor D1. Note that viewer V2 may not yet be a top contributor for other distributors. The top contributor tag registration could be performed by the user identifying unit 330 or another unit.

The potential top contributor tag indicates if a viewer, who is not yet a top contributor for a distributor, has the potential to become a top contributor for the distributor in a future timing (for example, 0.5 or 1 month later). In some embodiments, the potential top contributor tag indicates if the predicted contribution (or contribution prediction) from a viewer will exceed the threshold corresponding to a distributor in the future timing. The determination of the tag (or, the prediction) could be performed by the user identifying unit 330 by utilizing the ML model 370. If a viewer is already a top contributor for a distributor at the timing of the determination of the potential top contributor tag (such as viewer V2 with respect to distributor D1), the tag could be marked as NA (not applicable). In this embodiment, at the timing of the determination of the potential top contributor tag, viewer V3 is not yet registered as the top contributor with respect to distributor D1, but is tagged as potential top contributor. That means, based on the prediction result from the ML model 370, there is a high probability (or the probability is higher than a probability threshold) that viewer V3's contribution to distributor D1 will exceed the contribution threshold corresponding to distributor D1 in a future timing. In some embodiments, the contribution unit could be the point. In some embodiments, the contribution unit could be any monetary unit or money.

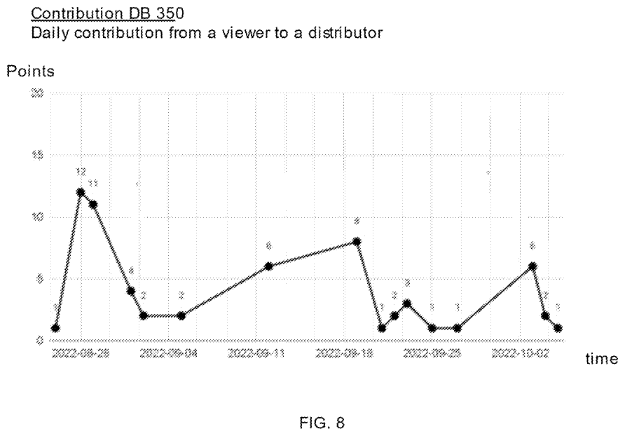

FIG. 8 shows exemplary daily contribution data between a viewer and a distributor. Daily contribution data shows the contribution, such as the points, the viewer gives the distributor each day. Similar contribution data is stored for each viewer/contributor pair. The contribution data could be stored as part of the contribution DB 350.

In some embodiments, if a viewer is tagged as a potential top contributor with respect to a distributor, it means the contribution prediction of the viewer with respect to the distributor reaches a certain threshold. The contribution prediction could be a predicted contribution amount (or a predicted probability of reaching a contribution amount) in a future timing.

In some embodiments, the ML model 370 (or one ML algorithm with ML model 370) is trained with past contribution data and/or interaction data to predict the potential top contributors. The past contribution data includes past contribution amounts of a viewer with respect to a distributor. The interaction data may include comment, gifting, and/or following data between a viewer and a distributor. The interaction data may include depositing amounts of a viewer on the platform. The above training data input into the ML model 370 may include a training set and a validation set, and the training process may include a supervised learning process.

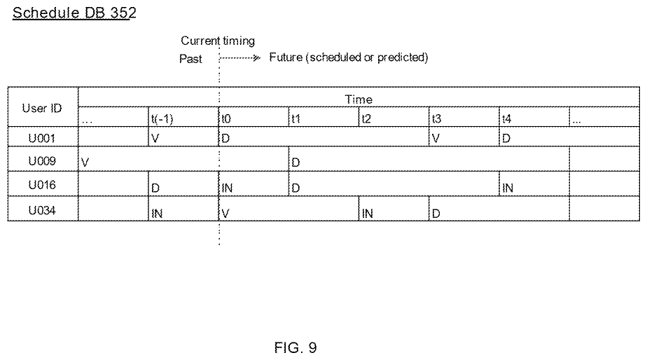

FIG. 9 is a data structure diagram showing an example of the schedule DB 352 of FIG. 3. The schedule DB 352 stores the schedule of viewing activity, marked as “V”, and distribution activity, marked as “D”, for the users. The mark “IN” indicates an inactive time when the user neither views nor distributes. The current timing separates the past portion and the future portion. The past portion is recorded according to real activities of the users. The future portion could be predetermined or could be predicted.

In some embodiments, the distribution schedule of a distributor at a future timing can be preset or pre-input by the distributor (or by an operator of the platform, in some embodiments). In some embodiments, the viewing schedule of a viewer at a future timing can be preset or pre-input by the viewer (or by an operator of the platform, in some embodiments). In some embodiments, distributors may want to align their distribution time with top contributors on the platform.

In some embodiments, a future distribution time of a distributor can be predicted by the ML model 370 (or a ML algorithm within the ML model 370). For example, the ML model 370 could be trained by past distribution schedule of the distributor, past distribution schedules of other distributors, past viewing schedule of the distributor's followers, and/or past viewing schedule of other viewers, to predict a future distribution time of the distributor. The above training data or behaviors could affect each other. For example, a viewer's viewing behavior or another distributor's distribution behavior may affect the distribution behavior of a certain distributor.

In some embodiments, a future viewing time of a viewer can be predicted by the ML model 370 (or a ML algorithm within the ML model 370). For example, the ML model 370 could be trained by past viewing schedules of the viewer, past viewing schedules of other viewers, past distribution schedules of distributors the viewer follows, and/or past distribution schedules of other distributors, to predict a future viewing time of the viewer. The above training data or behaviors could affect each other. For example, another viewer's viewing behavior or a distributor's distribution behavior may affect the viewing behavior of a certain viewer.

The ML model 370 could be a ML DB including one or more ML models. In some embodiments, the ML model 370 could be implemented within the server 10. The ML model 370 may include or utilize machine learning algorithms such as supervised learning algorithm or gradient boosting algorithm. In some embodiments, LightGBM (light gradient-boosting machine) could be implemented in contribution prediction for viewers. In some embodiments, decision tree algorithms could be implemented.

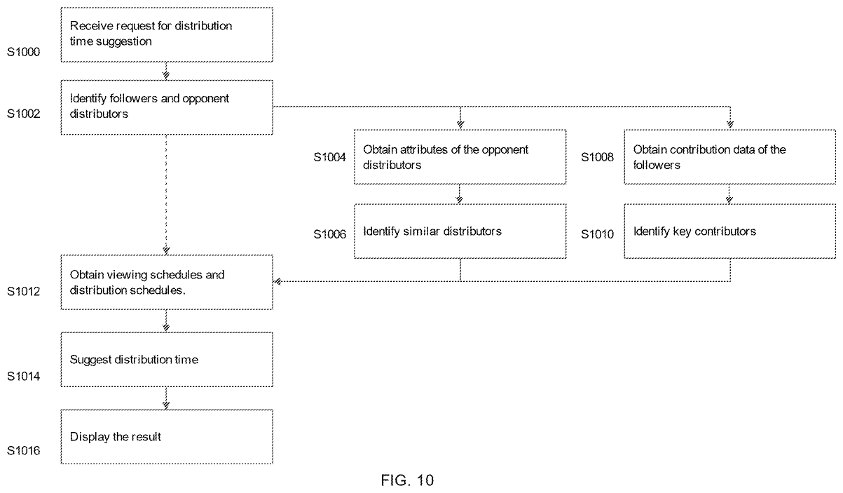

FIG. 10 shows an exemplary flow chart illustrating a method according to some embodiments of the present disclosure.

At step S1000, the server 10 (or the distribution information providing unit 302, for example) receives a request for distribution time suggestion. The request is associated with a distributor, and contains the distributor ID (or user ID of the distributor). The request could be from a distributor (or terminal of the distributor) or an operator of the streaming platform. In some embodiments, the request may be initiated before, after, or during live streaming of the distributor.

At step S1002, the user identifying unit 330 identifies the followers of the requesting distributor, and identifies other distributors (or opponent distributors) followed by those followers. The user identifying unit 330 may refer to the user DB 312 for the identification.

At step S1004, the distribution time suggesting unit 332 obtains the attributes of the opponent distributors and attributes of the requesting distributor from the user DB 312.

At step S1006, the distribution time suggesting unit 332 identifies similar distributors from the opponent distributors according to the attribute data. For example, if the number of common attributes (or distribution tags) shared by the requesting distributor and an opponent distributor reaches a threshold value, the opponent distributor may be deemed as a similar distributor. In some embodiments, a similarity score could be defined between two distributors. The more common attributes shared by the two distributors, the greater the similarity score is between them. For example, attributes (such as distribution tags) of each distributor can be expressed in a vector form, and a dot product of two attribute vectors (or tag vector) can be used to calculate the similarity score between the corresponding distributors. If an opponent distributor's similarity score with respect to the requesting distributor is greater than a threshold value, the opponent distributor may be deemed as a similar distributor. In some embodiments, if the followers of two distributors have an overlap that reaches a threshold value (such as a certain percentage), the two distributors may be referred to as similar distributors.

At step S1008, the distribution time suggesting unit 332 obtains contribution data (or contribution predictions) of the followers from the contribution DB 350.

At step S1010, the distribution time suggesting unit 332 identifies key contributors from the followers according to the contribution data. For example, followers tagged as “top contributor” and/or followers tagged as “potential top contributor” in the contribution DB 350 may be deemed as key contributors.

At step S1012, the distribution time suggesting unit 332 obtains the viewing schedules of the key contributors and the distribution schedules of the similar distributors from the schedule DB 352.

At step S1014, the distribution time suggesting unit 332 determines or suggests the distribution time for the distributor. In some embodiments, the distribution time is determined to have the least overlap with distribution time (or future distribution time) of the similar distributors. In some embodiments, the distribution time is determined to have the most overlap with viewing time (or future viewing time) of the key contributors.

At step S1016, the suggested distribution time is transferred to the user terminal of the requesting distributor and is displayed on the screen of the user terminal of the requesting distributor.

In some embodiments, after identifying the followers and the opponent distributors, the flow may go to step S1012. That is, the distribution time is determined to have the least overlap with distribution time (or future distribution time) of the opponent distributors. In some embodiments, the distribution time is determined to have the most overlap with viewing time (or future viewing time) of the followers.

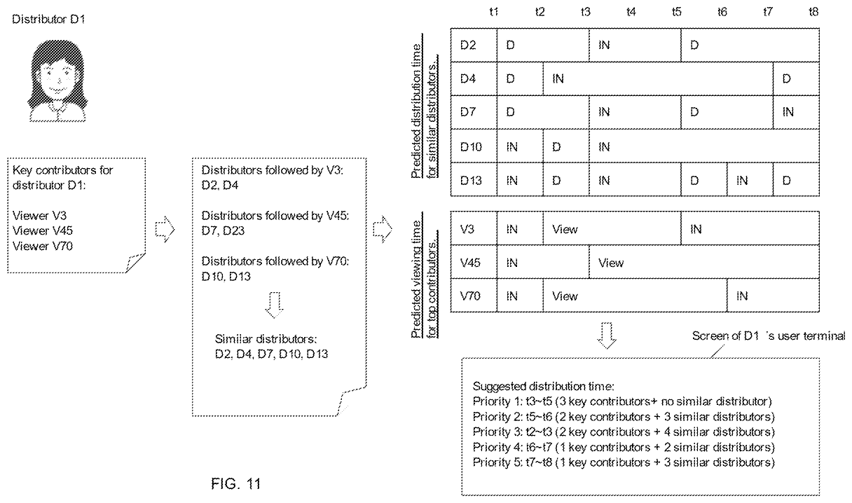

FIG. 11 shows an example of distribution time suggestion according to some embodiments of the present disclosure. Distributor D1 initiates a request for a distribution time suggestion. The request may be initiated before, after, or during live streaming of the distributor D1.

In this embodiment, key contributors (viewers V3, V45 and 70) for distributor D1 are identified first. Distributors followed by those key contributors respectively are then identified. Based on the attributes of those distributors, similar distributors (similar as distributor D1) are identified (D2, D4, D7, D10 and D13). Next, predicted distribution time (or scheduled distribution time) of the similar distributors and predicted viewing time of the top contributors are obtained to generate the suggested distribution time for distributor D1.

As shown on the screen of distributor D1's user terminal, the suggestion contains time zones with different priorities. Priority 1 is t3-t5, wherein there are 3 key contributors online and no similar distributor distributing. Priority 5 is t7-t8, wherein there are 1 key contributor and 3 similar distributors distributing. The priority setting can be different according to different weights given to each key contributor and each similar distributor. The weights can be adjusted according to actual practice.

One difference between the embodiment in FIG. 11 and the embodiment in FIG. 10 is that, in FIG. 10, all other distributors followed by the followers of the requesting distributor are identified, and the attributes of those other distributors are obtained. In FIG. 11, only distributors followed by key contributors of the requesting distributor are identified and used to determine the similar distributors subsequently.

In some embodiments, a top-level contributor may set his or her future viewing time in advance. The viewing schedule may be sent out to distributors by the contributor or by an operator of the platform. The distributors receiving the schedule notification may include distributors followed by the contributor and distributors not followed by the contributor. The mechanism allows distributors who want to interact with the top-level contributors to align their distribution time with viewing time of those contributors on the platform.

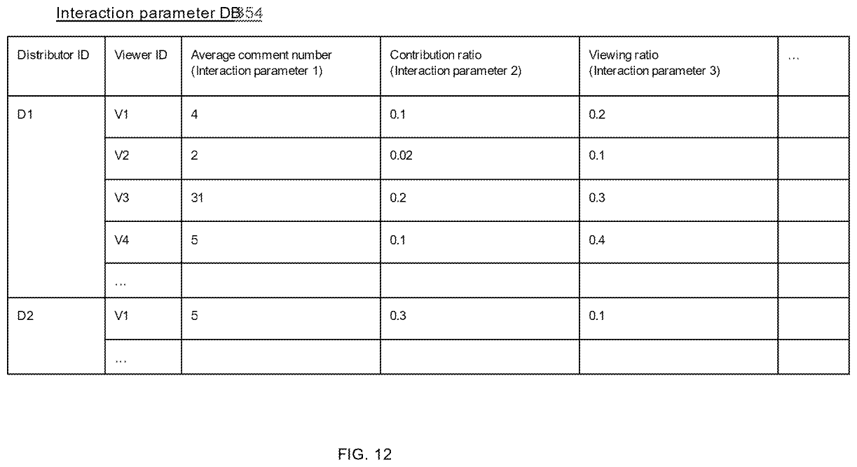

FIG. 12 is a data structure diagram showing an example of the interaction parameter DB 354 of FIG. 3. The interaction parameter DB 354 holds the distributor ID, the viewer ID, and one or more interaction parameters (interaction parameter 1, 2, . . . ).

The interaction parameters shown in FIG. 12 are in association with each distributor/viewer pair. Examples of the interaction parameters may include: contribution ratio, total contribution ratio, average comment number, viewing ratio, contribution correlation coefficient, comment correlation coefficient, and viewing ratio correlation coefficient.

The contribution ratio could be defined as [contribution from the viewer to the distributor in a period of time] divided by [contribution threshold of the distributor]. The total contribution ratio could be defined as [total contribution from the viewer on the platform (including contributions to other distributors) in a period of time] divided by [contribution threshold of the distributor]. The average comment number could be defined as [total comment number from the viewer to the distributor (or in the distributor's live stream)] divided by [numbers of live streams initiated by the distributor]. The viewing ratio could be defined as [time length of the viewer watching the distributor's live streams] divided by [total time length of the distributor's live streams].

The contribution correlation coefficient indicates the variation trend of the contribution amount (from the viewer to the distributor) with respect to time. The value of the contribution correlation coefficient could be between −1 and 1. A positive value means the contribution increases with time, and a negative value means the contribution decreases with time.

The comment correlation coefficient indicates the variation trend of the comment amount (from the viewer to the distributor) with respect to time. The value of the comment correlation coefficient could be between −1 and 1. A positive value means the comment increases with time, and a negative value means the comment decreases with time.

The viewing ratio correlation coefficient indicates the variation trend of the viewing ratio with respect to time. The value of the viewing ratio correlation coefficient could be between −1 and 1. A positive value means the viewer watches more (or more percentage) of the distributor's live stream, and a negative value means the viewer watches less (or less percentage) of the distributor's live stream.

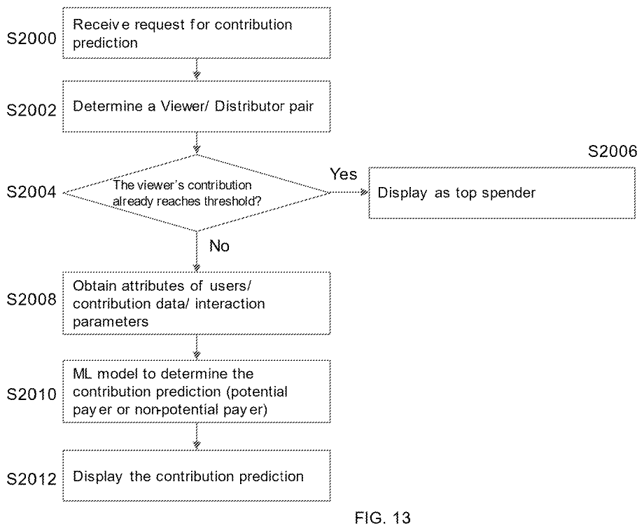

FIG. 13 shows another exemplary flow chart illustrating a method according to some embodiments of the present disclosure.

At step S2000, the server 10 (or the distribution information providing unit 302, for example) receives a request for contribution prediction. The request is associated with a viewer and a distributor, and contains the viewer ID and the distributor ID. The request could be from a distributor (or terminal of the distributor) or an operator of the streaming platform.

At step S2002, the server 10 determines/identifies the viewer and the distributor associated with the contribution prediction request according to the viewer ID and the distributor ID included in the request. The process could be performed by the user identifying unit 330, for example.

At step S2004, The server 10 determines if the viewer's current contribution to the distributor (in the current calculation session) already reaches the threshold of the distributor. If Yes, the flow goes to step S2006. If No, the flow goes to step S2008. The server 10 makes the determination by referring to the contribution DB 350. The determination process could be performed by the user identifying unit 330, for example.

At step S2006, the viewer is displayed as a top contributor at the requesting side. For example, the viewer is displayed as a top contributor on a screen of the user terminal of the distributor who initiated the contribution prediction request. Specifically, the server 10 transmits the result of step S2004, which shows the viewer is already a top contributor for the distributor, to the requesting side, and enables the requesting side to display the viewer as a top contributor.

At step S2008, the user identifying unit 330 refers to the user DB 312 for the attributes of users (attributors of the viewer and the distributor, and attributors of other viewers and other distributors). The user identifying unit 330 refers to the contribution DB 350 for the contribution data between viewers and distributors. The user identifying unit 330 refers to the interaction parameter DB 354 for the interaction parameters (between the viewer and the distributor, and/or between the viewer and other distributors, for example).

At step S2010, the user identifying unit 330 inputs the data or information received at step S2008 into the ML model 370. The ML model 370 determines or calculates the contribution prediction of the viewer with respect to the distributor according to the above inputs, and transmits a contribution prediction result to the user identifying unit 330. In some embodiments, the contribution prediction result could be a probability (or probability value) of how likely the contribution (or current contribution) of the viewer (with respect to the distributor) will exceed the contribution threshold of the distributor in a future timing (for example, 1 or 0.5 month later). The user identifying unit 330 may then determine the value (or type/class) of the potential top contributor tag (in the contribution DB 350) of the viewer with respect to the distributor by comparing the probability and a probability threshold. The probability threshold could be determined by the operator of the streaming platform. The probability threshold could be, for example, 50%, 75%, or 90%.

At step S2012, the contribution prediction result is displayed at the requesting side. For example, the predicted probability value (or the potential top contributor tag, which is Yes or No) may be displayed along with the viewer's viewer ID on a screen of the user terminal of the distributor who initiated the contribution prediction request. Specifically, the server 10 transmits the prediction result of step S2010 to the requesting side, and enables the requesting side to display the prediction result.

In some embodiments, the contribution prediction processes described above are performed in a real time manner. That is, when the server 10 receives a contribution prediction request with respect to a viewer/distributor pair (for example, when the viewer joins a chat room of the distributor and the distributor initiated a contribution prediction request regarding the viewer), the user identifying unit 330 accesses the user DB 312, the contribution DB 350, and the interaction parameter DB 354 for the attribute data, the contribution data, and the interaction parameter data in a real time manner. The above feature data are then input into the ML model 370 to generate the prediction result in a real time manner. The update of the stream DB 310, the user DB 312, the gift DB 314, the contribution DB 350, and/or the interaction parameter DB 354 are also in a real time manner. The database update could be realized by communication with services or databases outside the server 10, such as a cloud service, such as the BigQuery service.

In some embodiments, a batch process could be incorporated or utilized in the contribution prediction process. For example, the update of the stream DB 310, the user DB 312, the gift DB 314, the contribution DB 350, and/or the interaction parameter DB 354 are performed at a fixed timing once per day. The updated data (such as the attribute data, the contribution data and the interaction parameter data) are used as features by the ML model 370 to generate the contribution prediction for each viewer/distributor pair. The contribution prediction results are then stored in the contribution DB 350, for example. Afterwards, when a viewer joins a chat room of a distributor and the distributor initiates a contribution prediction request regarding the viewer, the user identifying unit 330 just accesses the prediction result (which could be prepared or calculated in the previous day) in the contribution DB 350 and responds to the distributor. In some embodiments, the batch style prediction process may lack the latest information in the prediction calculation, but may save the database update time and/or the ML model inference time. In some embodiments, the batch style prediction process may deliver the prediction result in a faster manner and provide better user experience.

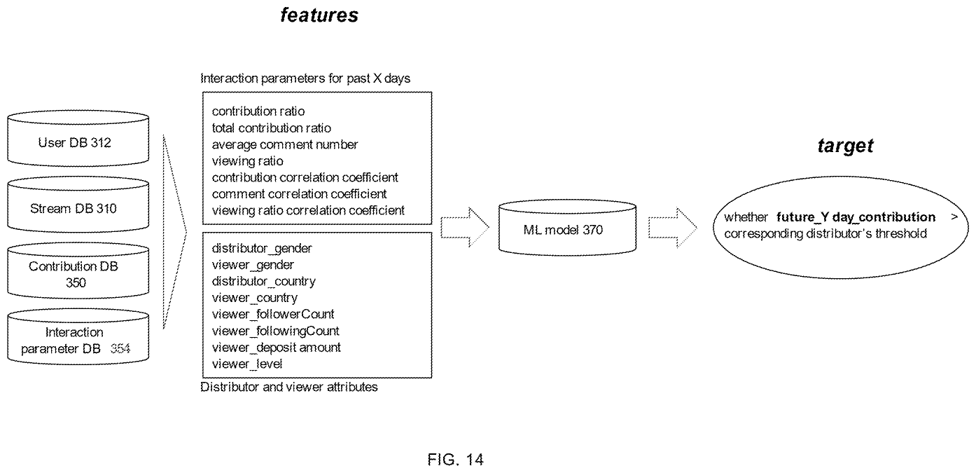

FIG. 14 shows an example of how the ML model 370 determines or calculates the contribution prediction according to some embodiments of the present disclosure.

As shown in FIG. 14, features that are input into the ML model 370 include the interaction parameters between the viewer and the distributor, attributes of the distributor, and attributes of the viewer. The features are taken from various databases such as the stream DB 310, the user DB 312, the contribution DB 350 and/or the interaction parameter DB 354. Features (or values of the features) in the past X days are input into the ML model 370. The target is to determine whether the contribution of the viewer with respect to the distributor will exceed the contribution threshold of the distributor in a future timing (Y days in the future, for example). In some embodiments, the target is to produce a probability indicating how likely the contribution of the viewer with respect to the distributor will exceed the contribution threshold of the distributor in a future timing (Y days in the future).

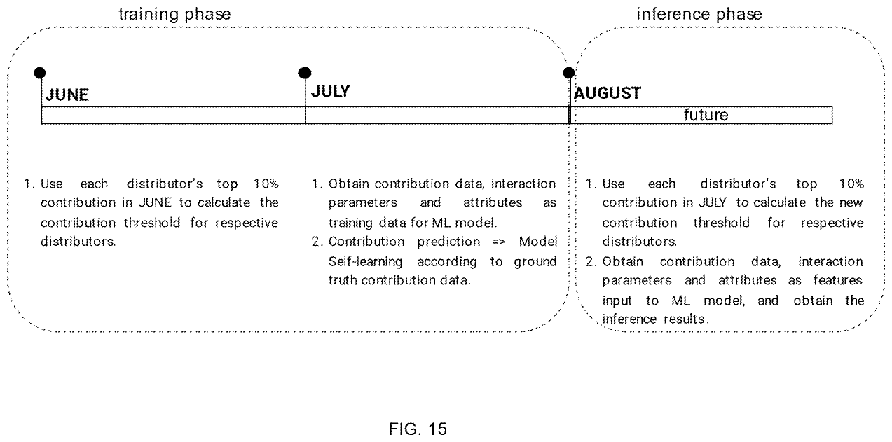

FIG. 15 shows exemplary training and inference phases of the ML model 370 according to some embodiments of the present disclosure. In this embodiment, the ML model 370 periodically (for example, weekly, monthly, yearly, etc) is re-trained using the latest available data. For example, the ML model 370 is re-trained on the first day of each month. In the (re-)training phase, data obtained in the last month is used for training and validation and data obtained in the month before last is used to calculate a threshold. The (re-)training may be performed manually or automatically. In the example of FIG. 15, the training phase includes the JUNE period and the JULY period, which are the past. The inference phase includes the AUGUST period, which is the future.

At the JUNE period (or end of JUNE period), top 10% (or first 10% quantile, or the 10th greatest contribution) of each distributor's total received contribution in JUNE is used to calculate the contribution threshold for each respective distributor.

At the JULY period, contribution data between each viewer/distributor pair, interaction parameters between each viewer/distributor pair, attributes of each viewer, and attributes of each distributor are obtained as training data for the ML model 370. The ML model 370 may utilize the training data as training set and validation set, make contribution prediction, and perform self-learning according to the ground truth contribution data. The contribution prediction could be a probability of how likely a viewer's contribution to a distributor will exceed the contribution threshold (calculated from JUNE period data) of the distributor in a timing within the JULY period.

At the AUGUST period as an inference phase, top 10% (or first 10% quantile, or the 10th greatest contribution) of each distributor's total received contribution in JULY is used to calculate the new contribution threshold for each respective distributor. Contribution data between each viewer/distributor pair, interaction parameters between each viewer/distributor pair, attributes of each viewer, and attributes of each distributor are obtained as new features input into the ML model 370. The ML model 370 then delivers the inference results, which include the probability of how likely a viewer's contribution to a distributor will exceed the new contribution threshold of the distributor in a future timing.

In some embodiments, feature data in past 10 days (X=10) are used by the ML model 370 to generate the contribution prediction in the future 14 days (or 14 days from now, Y=14). For example, when the contribution prediction is calculated on August 14th, the feature data input into the ML model 370 includes the contribution data, the attribute data, and the interaction parameter data within August 5th to August 14th (or August 4th to August 13th), and the output of the ML model 370 includes the contribution prediction on August 27th (or August 28th).

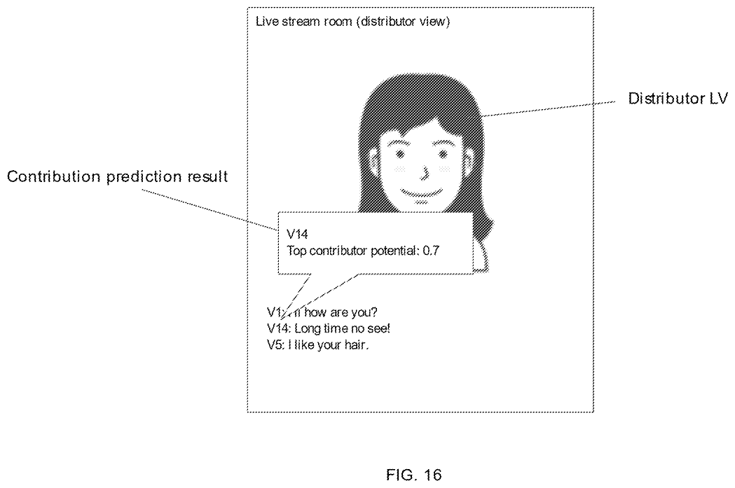

FIG. 16 shows an example of a live streaming screen on the user terminal of a distributor according to some embodiments of the present disclosure.

The distributor LV may tap on the viewer ID (or viewer name) V14 to request for the contribution prediction. The contribution prediction result calculated by the ML model 370 is then displayed. In this embodiment, the result is displayed as a probability (0.7=70%) of how likely viewer V14 is going to be a top contributor for distributor LV (which means that contribution from viewer V14 exceeds the contribution threshold of distributor LV) in a future timing. In some embodiments, the potential top contributor tag could be shown, which indicates if viewer V14 is a potential top contributor for distributor LV or not.

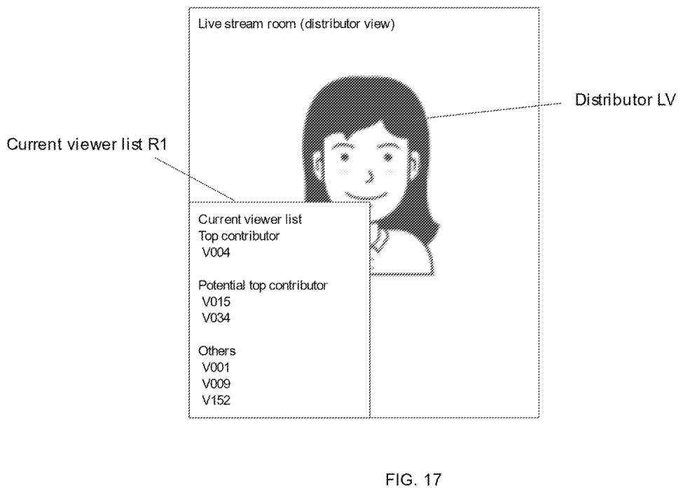

FIG. 17 shows an example of a live streaming screen on the user terminal of a distributor according to some embodiments of the present disclosure.

The distributor's device, during the live stream and in response to the distributor's instruction to show a current viewer list, sends a request to obtain the current viewer list to the server 10. The request includes the stream ID of the live stream. The server 10 identifies, by referring to the stream DB 310, the list of viewer IDs which correspond to the stream ID included in the request. The server 10 then refers to the contribution DB 350 to determine, for each viewer ID in the identified list, whether the viewer (of the respective viewer ID) is tagged as a top contributor or as a potential top contributor or none of those. The server 10 adds the result of the determination to the respective viewer ID in the identified list. The server 10 sends the identified list to the requesting distributor's device. The device generates a current viewer list region R1 and shows it in the live stream room screen. The region shows the list of current viewers. In the region, the viewer(s) tagged as top contributor is shown on the top, and shown below it is the viewer(s) tagged as potential top contributor. The top contributors and/or the potential top contributors are displayed in a more prominent manner than that of others. By doing so, the distributor can easily recognize who he/she should pay attention to and/or who he/she should put more efforts to communicate with.

In some embodiments, the batch style contribution prediction process mentioned above can be utilized in determining the top contributor tag and/or the potential top contributor tag in the contribution DB 350 in the embodiment of FIG. 17. That may save time compared with determining or calculating those tags for all current viewers in a real time manner.

Referring to FIG. 7, FIG. 8 and FIG. 12, the features input into the ML model 370 include the contribution data from the contribution DB 350 and the interaction parameters from the interaction parameter DB 354. The contribution data and the interaction parameters are specific to or in association with each viewer/distributor pair. Therefore, the contribution prediction for a viewer with respect to a distributor, delivered by the ML model 370, may not only be correlated with interaction between the viewer and the distributor, but may also be correlated with interaction between the viewer and other distributors. That is, the contribution prediction for a viewer with respect to a distributor may be determined, by the ML model 370, according to the interaction parameters and/or the contribution data between the viewer and another distributor.

For example, in some embodiments, the ML model 370 detects or determines a contribution increase (or contribution increase trend) of viewer V1 with respect to distributor D2 according to the contribution data in the contribution DB350 (or according to a value of the contribution correlation coefficient between viewer V1 and distributor D2 in the interaction parameter DB 354). The ML model 370 may then determine the contribution prediction of viewer V1 with respect to distributor D1 to be greater, even though there is no obvious contribution increase trend of viewer V1 with respect to distributor D1 at the timing of the prediction. In some embodiments, the contribution increase from viewer V1 to distributor D2 may indicate an increase in the ability or the willingness to contribute for viewer V1. Therefore, by presenting viewer V1 as having increased contribution prediction to distributor D1, distributor D1 can focus more on or interact more with viewer V1 to increase the chance of receiving higher contribution from viewer V1.

In some embodiments, the ML model 370 detects or determines an attribute of distributor D1 to be different from or opposite to an attribute of distributor D2. In that case, the contribution prediction of a viewer with respect to distributor D1, determined by the ML model 370, may be inversely correlated with a value of the interaction parameter of the viewer with respect to distributor D2. For example, if attributes of distributor D1 and distributor D2 indicate that they usually distribute political contents and have opposite political stands, a viewer V1 showing increased interest in distributor D2 may indicate decreased interest in distributor D1. Therefore, the ML model 370 may determine the contribution prediction of viewer V1 with respect to distributor D1 to be lower if the interaction parameters (such as contribution correlation coefficient, comment correlation coefficient, or viewing ratio correlation coefficient) between viewer V1 and distributor D2 show increased interaction or increased contribution. Distributor D1 may then, based on the prediction result, focus more on or interact more with other viewers with higher contribution potentials. In some embodiments, the attributes of a user may include the user's political stand, which may be determined by a machine learning model according to the user's speech or comment detected by a detecting unit.

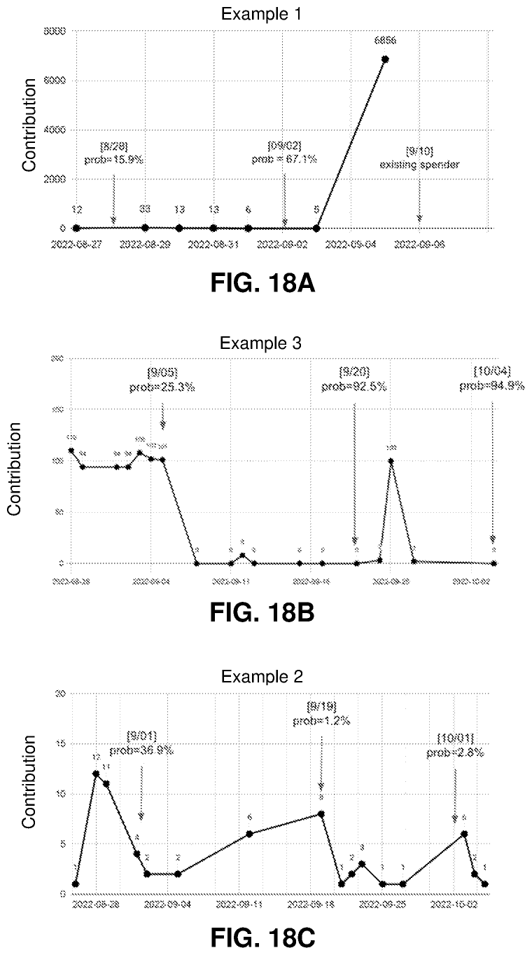

FIGS. 18(a), 18(b) and 18(c) show examples of contribution prediction according to some embodiments of the present disclosure. The X axis is the daily contribution. The Y axis is the timeline. The contribution prediction is a probability of how likely the viewer is going to be a top contributor for the distributor in a future timing.

In example 1 shown in FIG. 18(a), the predicted probability increased from 15.9%, calculated at 8/28, to 67.1%, calculated at 9/2. The viewer may be tagged as a potential top contributor at 9/2. As shown, the actual contribution increased afterwards and the viewer became a top contributor at 9/10.

In example 2 shown in FIG. 18(b), the predicted probability decreased from 36.9%, calculated at 9/1, to 1.2%, calculated at 9/19. The viewer is not tagged as a potential top contributor. As shown, the actual contribution stayed low afterwards and the viewer did not become a top contributor.

In example 3 shown in FIG. 18(c), the predicted probability increased from 25.3%, calculated at 9/5, to 92.5%, calculated at 9/20. The viewer may be tagged as a potential top contributor at 9/20. As shown, the actual contribution increased a bit afterwards. In actual practice, the distributor may refer to the prediction result at 9/20 and start paying more attention to (or start interacting more with) the viewer, to maximize the contribution potential from the viewer and/or to actually turn the viewer into a top contributor.

When a distributor starts a live stream, notifications (or push notifications) regarding the live stream will be sent to viewers that follow the distributor. In some embodiments, when a distributor starts a live stream, the streaming system identifies the potential top contributors of the distributor (by referring to the contribution DB 350), and sends the notifications to those top contributors only or with a higher priority. That may maximize the effectiveness of the notifications in an environment wherein resources regarding notification processes (such as bandwidths or CPU usage of a notification system communicating with the server 10) are limited. The batch style contribution prediction process can be utilized for updating the potential top contributor tags in the contribution DB 350 in advance, to speed up the process of identifying the potential top contributors, and to speed up the notification process.

The present disclosure can identify the potential high contributors for a distributor, such that the distributor can interact more with them or focus more on them. The present disclosure can identify those viewers who are already high contributors or loyal contributors for a distributor, such that the distributor may keep current interaction with them. The present disclosure can identify those viewers who are less likely to be high contributors for a distributor, such that the distributor may interact more with other viewers with higher contribution potentials.

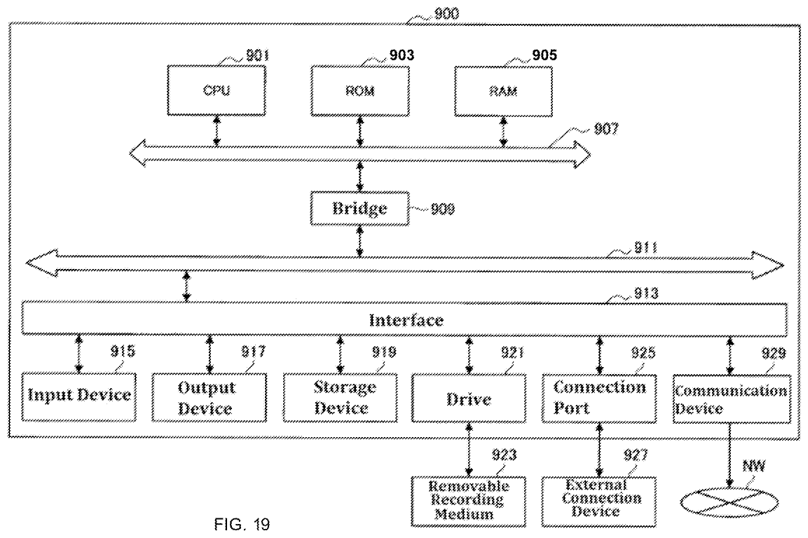

Referring to FIG. 19, the hardware configuration of the information processing device will be now described. FIG. 19 is a block diagram showing an example of a hardware configuration of the information processing device according to some embodiments of the present disclosure. The illustrated information processing device 900 may, for example, realize the server 10 and/or the user terminals 20 and 30 in some embodiments.

The information processing device 900 includes a CPU 901, ROM (Read Only Memory) 903, and RAM (Random Access Memory) 905. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). In addition to or instead of the CPU 901, the information processing device 900 may also include a DSP (Digital Signal Processor) or ASIC (Application Specific Integrated Circuit).

The CPU 901 functions as an arithmetic processing device and a control device, and controls all or some of the operations in the information processing device 900 according to various programs stored in the ROM 903, the RAM 905, the storage device 919, or the removable recording medium 923. For example, the CPU 901 controls the overall operation of each functional unit included in the server 10 and the user terminals 20 and 30 in some embodiments. The ROM 903 stores programs, calculation parameters, and the like used by the CPU 901. The RAM 905 serves as a primary storage that stores a program used in the execution of the CPU 901, parameters that appropriately change in the execution, and the like. The CPU 901, ROM 903, and RAM 905 are interconnected to each other by a host bus 907 which may be an internal bus such as a CPU bus. Further, the host bus 907 is connected to an external bus 911 such as a PCI (Peripheral Component Interconnect/Interface) bus via a bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OLED, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for a removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 905. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is an imaging element such as a CCD (Charge Coupled Device) or CMOS (Complementary Metal Oxide Semiconductor), and a device that captures an image of the real space using various elements such as lenses for controlling image formation of a subject on the imaging element to generate the captured image. The image capturing device may capture a still image or may capture a moving image.

The configuration and operation of the live streaming system 1 in the embodiment have been described. This embodiment is a merely example, and it is understood by those skilled in the art that various modifications are possible for each component and a combination of each process, and that such modifications are also within the scope of the present disclosure.

The present disclosure can suggest the distribution time for the distributor to keep the followers from being distracted by other distributors. The present disclosure can suggest the distribution time for the distributor to reach more potential contributors. The present disclosure can suggest the distribution time for the distributor to achieve better rewards or better interaction with viewers in an efficient manner.

The processing and procedures described in the present disclosure may be realized by software, hardware, or any combination of these in addition to what was explicitly described. For example, the processing and procedures described in the specification may be realized by implementing a logic corresponding to the processing and procedures in a medium such as an integrated circuit, a volatile memory, a non-volatile memory, a non-transitory computer-readable medium and a magnetic disk. Further, the processing and procedures described in the specification can be implemented as a computer program corresponding to the processing and procedures, and can be executed by various kinds of computers.

Furthermore, the system or method described in the above embodiments may be integrated into programs stored in a computer-readable non-transitory medium such as a solid state memory device, an optical disk storage device, or a magnetic disk storage device. Alternatively, the programs may be downloaded from a server via the Internet and be executed by processors.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the patent application scope.

### DESCRIPTION OF REFERENCE NUMERALS

1 communication system
10 server
20 user terminal
30, 30a, 30b user terminal
LV distributor
AU1, AU2 viewer
VD, VD1, VD2 video image
NW network
30 user terminal
100 distribution unit
102 image capturing control unit
104 audio control unit
106 video transmission unit
108 distributor-side UI control unit
200 viewing unit
202 viewer-side UI control unit
204 superimposed information generation unit
206 input information transmission unit
302 distribution information providing unit
304 relay unit
306 gift processing unit
308 payment processing unit
310 stream DB
312 user DB
314 gift DB
330 user identifying unit
332 distribution time suggesting unit
350 contribution DB
352 schedule DB
354 interaction parameter DB
370 ML model
R1 current viewer list
900 information processing device
901 CPU
903 ROM
905 RAM
907 host bus
909 bridge
911 external bus
913 interface
915 input device
917 output device
919 storage device
921 drive
923 removable recording medium
925 connection port
927 external connection device
929 communication device

The present techniques will be better understood with reference to the following enumerated embodiments:

A1. A method for viewer contribution prediction, executed by a server, comprising:
determining a contribution amount of a viewer with respect to a first distributor to be less than a contribution threshold of the first distributor;
obtaining a value of an interaction parameter of the viewer with respect to the first distributor; and
determining a contribution prediction of the viewer with respect to the first distributor according to the value of the interaction parameter of the viewer with respect to the first distributor by a machine learning model.

A2. The method according to A1, further comprising:
obtaining an attribute of the viewer; and
determining the contribution prediction of the viewer with respect to the first distributor according to the attribute of the viewer by the machine learning model.

A3. The method according to A1, further comprising:
obtaining a value of an interaction parameter of the viewer with respect to a second distributor; and
determining the contribution prediction of the viewer with respect to the first distributor according to the value of the interaction parameter of the first viewer with respect to the second distributor by the machine learning model.

A4. The method according to claim A3, further comprising:
determining a contribution increase of the viewer with respect to the second distributor according to the value of the interaction parameter of the viewer with respect to the second distributor; and
determining the contribution prediction of the viewer with respect to the first distributor to be greater.

A5. The method according to claim A3, further comprising:
determining an attribute of the first distributor to be different from an attribute of the second distributor,
wherein the determined contribution prediction of the viewer with respect to the first distributor is inversely correlated with the value of the interaction parameter of the viewer with respect to the second distributor.

A6. The method according to claim A1, wherein the machine learning model has been trained with values of interaction parameters of viewers with respect to distributors and contribution amounts of the viewers with respect to the distributors.

A7. The method according to claim A1, wherein the contribution prediction is a probability for the viewer to reach the contribution threshold of the first distributor at a future timing.

A8. The method according to claim A1, further comprising:
displaying the determined contribution prediction of the viewer with respect to the first distributor on a display of a terminal of the first distributor during live streaming of the first distributor.

A9. A system for viewer contribution prediction, comprising one or a plurality of processors, wherein the one or plurality of processors execute a machine-readable instruction to perform:
determining a contribution amount of a viewer with respect to a first distributor to be less than a contribution threshold of the first distributor;
obtaining a value of an interaction parameter of the viewer with respect to the first distributor; and
determining a contribution prediction of the viewer with respect to the first distributor according to the value of the interaction parameter of the viewer with respect to the first distributor by a machine learning model.

A10. A non-transitory computer-readable medium including a program for viewer contribution prediction, wherein the program causes one or a plurality of computers to execute:
determining a contribution amount of a viewer with respect to a first distributor to be less than a contribution threshold of the first distributor;
obtaining a value of an interaction parameter of the viewer with respect to the first distributor; and
determining a contribution prediction of the viewer with respect to the first distributor according to the value of the interaction parameter of the viewer with respect to the first distributor by a machine learning model.

What is claimed is:

1. A method for distribution time suggestion, executed by a server, comprising:
obtaining a first list of viewers in association with a first distributor;
obtaining data of the viewers in the first list;
obtaining a second list of distributors in association with the viewers in the first list;
obtaining data of the distributors in the second list; and
determining a distribution time for the first distributor according to the data of the viewers in the first list and the data of the distributors in the second list.

2. The method according to claim 1, wherein the data of the viewers in the first list includes contribution predictions of the viewers.

3. The method according to claim 1, wherein the data of the distributors in the second list includes similarity scores of the distributors with respect to the first distributor.

4. The method according to claim 1, wherein the data of the distributors in the second list includes distribution schedules of the distributors.

5. The method according to claim 1, wherein the distribution time is determined to have the least overlap with distribution time of the distributors in the second list having similar attributes with the first distributor.

6. The method according to claim 2, wherein the distribution time is determined to have the most overlap with viewing time of the viewers in the first list whose contribution predictions are greater than a contribution threshold.

7. The method according to claim 2, wherein the contribution predictions of the viewers are predicted by a machine learning model trained with past contribution data of the viewers in the first list with respect to the first distributor.

8. The method according to claim 4, wherein the distribution schedules of the distributors are predicted by a machine learning model trained with past distribution schedules of the distributors in the second list and past viewing schedules of the viewers in the first list.

9. The method according to claim 1, wherein the data of the viewers in the first list includes future viewing schedule of the viewers.

10. The method according to claim 1, further comprising:
providing, to a user terminal of the first distributor and via a network, a suggestion including the determined distribution time.

11. A system for distribution time suggestion, comprising one or a plurality of processors, wherein the one or plurality of processors execute a machine-readable instruction to perform:
obtaining a first list of viewers in association with a first distributor;
obtaining data of the viewers in the first list;
obtaining a second list of distributors in association with the viewers in the first list;
obtaining data of the distributors in the second list; and
determining a distribution time for the first distributor according to the data of the viewers in the first list and the data of the distributors in the second list.

12. A non-transitory computer-readable medium including a program for distribution time suggestion, wherein the program causes one or a plurality of computers to execute:
obtaining a first list of viewers in association with a first distributor;
obtaining data of the viewers in the first list;
obtaining a second list of distributors in association with the viewers in the first list;
obtaining data of the distributors in the second list; and
determining a distribution time for the first distributor according to the data of the viewers in the first list and the data of the distributors in the second list.
